(19) United States
(12) Patent Application Publication
(10) Pub. No.: US 2017/0102832 A1
(43) Pub. Date: Apr. 13, 2017

(54) Systems and Methods for Displaying Content, Based on Selections of Unlinked Objects

(71) Applicant: MASTERCARD INTERNATIONAL INCORPORATED, Purchase, NY (US)

(72) Inventor: Piruthiviraj Sivaraj, High Ridge, MO (US)

(21) Appl. No.: 14/878,282

(22) Filed: Oct. 8, 2015

(51) Int. Cl. G06F 3/0482; G06F 3/0488; G06F 17/30; G06F 3/0484

(52) U.S. Cl. CPC G06F 3/0482; G06F 3/04842; G06F 3/0488; G06F 17/30867; G06F 17/30554

(57) ABSTRACT

Methods and systems are described for use in displaying content, in response to a selection of an unlinked object such as text. An exemplary method includes causing an interface to be displayed at a communication device. The interface includes an object, such as a text segment, that is unlinked. The exemplary method further includes receiving, at the communication device, a selection from a user to the interface of the unlinked object, and causing content based on the selected unlinked object to be displayed to the user at the communication device.

### FIELD

The present disclosure generally relates to systems and methods for displaying content to users based on selections by the users of unlinked objects from interfaces, with the displayed content being related to the selected objects, either alone or potentially in context of the interfaces or in context of predefined user preferences.

### BACKGROUND

This section provides background information related to the present disclosure which is not necessarily prior art.

Dissemination of information is commonly provided through interfaces at webpages and web-based applications, in which users are permitted to navigate within the interfaces to access information about one or more topics, or between the interfaces and other interfaces to access different information. Often, the interfaces include links, i.e., hyperlinks, which may be selected by the users to view additional content, or particular content, as indicated by the links. By selecting, or even hovering over the links, the users are able to view the additional content, often as navigation movements to other parts of the interfaces (or associated webpages/applications), as text boxes, or as different interfaces (or different webpages). For example, an interface related to credit transactions may include a link, which, when selected by a user, opens a new interface with additional information about an aspect of credit transactions. In another example, an interface divided into separate sections may include links in an executive summary, or in a table of contents, that, when selected, auto-locate the user to one of the separate sections of the interface. In any case, the links are created and defined as part of the interfaces.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure for use in displaying content to a user, based on selection of unlinked objects, by the user, within an interface shown at a communication device;

FIG. 2 is a block diagram of an exemplary computing device, that may be used in the system of FIG. 1;

FIG. 3 is an exemplary method suitable for use in the system of FIG. 1 for displaying content to a user based on selection of unlinked text, or simple text, within an interface shown on a communication device; and

FIGS. 4-8 illustrate pages of an exemplary interface that may be displayed in connection with the system of FIG. 1 and/or the method of FIG. 3.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Information is often disseminated in the form of interfaces, available through webpages or web-based applications. The interfaces often include text, symbols, images, videos, other subject matter, etc. (broadly, objects), which are defined within the interfaces as links, such that when users select the objects in the interfaces, the users (by instructions associated with the links) are directed to additional content (or additional information) linked thereto. However, creating such links within the interfaces increases the complexity of building webpages and applications, because the links need to be particularly specified and need to point to the correct additional content. Further, the links need to be maintained, so that linked content is not eliminated, or revised at a different address, thereby breaking the link to that additional content. The systems and methods herein, for example, permit the display of additional content to a user, upon selection by the user of an unlinked object in an interface. The additional content is located, for example, by searching for the selected unlinked object within the interface or across a network, etc. The resulting content is then displayed to the user. Moreover, the systems and methods herein may rely on a subject of the interface from which the object is selected, or on a user preference or profile associated with the user, as desired, to provide appropriate context for the search.

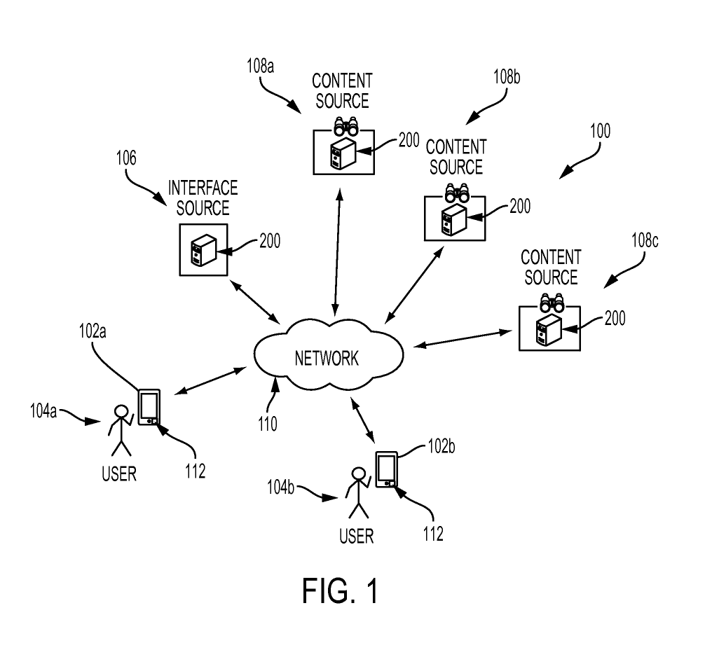

With reference now to the drawings, FIG. 1 illustrates an exemplary system 100, in which one or more aspects of the present disclosure may be implemented. Although components of the system 100 are presented in one arrangement, it should be appreciated that other exemplary embodiments may include the same or different components arranged otherwise, for example, depending on manners in which interfaces are accessed and displayed, types of unlinked objects included in interfaces, manners in which content is identified from unlinked objects included in interfaces, etc.

The illustrated system 100 generally includes communication devices 102a-b accessible to users 104a-b, an interface source 106, and multiple content sources 108a-c, each coupled to (and in communication with) network 110. Each of the communication devices 102a-b is illustrated as a smartphone in FIG. 1. However, one or more of the communication devices 102a-b may include a different device such as, for example, a tablet, a personal computer, a personal digital assistant (PDA), etc. In addition, each of the content sources 108a-c is illustrated as a search engine in FIG. 1 (e.g., Google®, Bing®, Yahoo®, etc.). However, one or more of the content sources 108a-c, or other content sources that may be included in the system 100, may include a different source of content, for example, a data structure comprising particular information (broadly, content) such as magazines or other periodicals, surveys, financial data, governmental regulations, information repositories, reports (e.g., marketing agency reports, etc.), historical data/information, etc., or even e-books the users 104a-b are reading.

The network 110 of the system 100 may include, without limitation, a wired and/or wireless network, one or more local area network (LAN), wide area network (WAN) (e.g., the Internet, etc.), mobile network, other network as described herein, and/or other suitable public and/or private network capable of supporting communication among two or more of the illustrated components, or any combination thereof. In one example, the network 110 includes multiple networks, where different ones of the multiple networks are accessible to different ones of the illustrated components in FIG. 1 (e.g., to different ones of the users 104a-b, etc.).

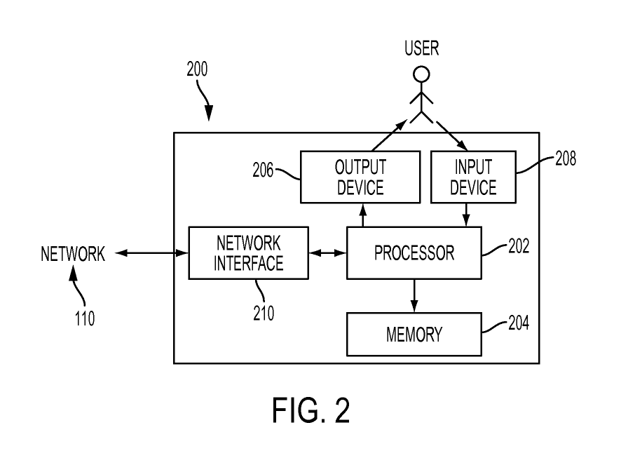

FIG. 2 illustrates an exemplary computing device 200 that can be used in the system 100. The computing device 200 may include, for example, one or more servers, personal computers, laptops, tablets, smartphones, PDAs, televisions, etc. In addition, the computing device 200 may include a single computing device, or it may include multiple computing devices located in close proximity or distributed over a geographic region. However, the system 100 should not be considered to be limited to the computing device 200, as described below, as different computing devices and/or arrangements of computing devices may be used. In addition, different components and/or arrangements of components may be used in other computing devices.

In the exemplary embodiment of FIG. 1, the interface source 106 and the content sources 108a-c are each illustrated as including computing device 200, coupled to (and in communication with) the network 110. Further, the computing devices 200 associated with the interface source 106 and the content sources 108a-c, for example, may include a single computing device, or multiple computing devices located in close proximity or distributed over a geographic region, so long as the computing devices are specifically configured to function as described herein. In addition, each of the communication devices 102a-b in the system 100, associated with users 104a-b, can also be considered a computing device consistent with computing device 200.

With reference to FIG. 2, the exemplary computing device 200 includes a processor 202 and a memory 204 that is coupled to (and in communication with) the processor 202. The processor 202 may include one or more processing units (e.g., in a multi-core configuration, etc.). The computing device 200 is programmable to perform one or more operations described herein by programming the processor 202 and/or the memory 204. The processor 202 may include, but is not limited to, a central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein, etc.

The memory 204, as described herein, is one or more devices that permit data, instructions, etc., to be stored therein and retrieved therefrom. The memory 204 may include one or more computer-readable storage media such as, without limitation, dynamic random access memory (DRAM), static random access memory (SRAM), read only memory (ROM), solid state devices, flash drives, and/or hard disks. The memory 204 may be configured to store, without limitation, user profiles, user preferences, interface scripts (or instructions), subject-specific content, and other information, content, or data as described herein, etc. Furthermore, in various embodiments, computer-executable instructions may be stored in the memory 204 for execution by the processor 202 to cause the processor 202 to perform one or more of the operations and/or steps described herein, such that memory 204 is a physical, tangible, and non-transitory computer-readable storage media. It should be appreciated that memory 204 may include a variety of different memories, each implemented in one or more of the operations and/or steps described herein.

In the exemplary embodiment, computing device 200 also includes an output device 206 that is coupled to (and in communication with) the processor 202. Output device 206 may include, without limitation, a liquid crystal display (LCD), a light-emitting diode (LED) display, an organic LED (OLED) display, and/or an “electronic ink” display, a printer, etc. In some embodiments, output device 206 includes multiple devices. In use, the output device 206 outputs to a user (e.g., one of users 104a-b, etc.) by, for example, displaying and/or otherwise outputting information such as, but not limited to, interfaces including a variety of content, different objects (e.g., text, symbols, images such as pictures and logos, videos, etc.) included in the interfaces, and/or any other type of data. The interfaces may include, for example, webpages, application interfaces, dialogue and/or text windows, etc. In addition, in some embodiments, the computing device 200 may cause the interfaces to be displayed at the output device of another computing device. For example, a server hosting a website may cause, in response to one or more inputs (from the user, or otherwise) multiple interfaces (e.g., multiple webpages, etc.) to be displayed at one or more of the communication devices 102a-b, etc.

The computing device 200 further includes an input device 208 that receives input from the user. The input device 208 is coupled to (and in communication with) the processor 202 and may include, for example, a keyboard, a pointing device, a mouse, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both an output device and an input device.

In addition, the illustrated computing device 200 also includes a network interface 210 coupled to (and in communication with) the processor 202 (and the memory 204). The network interface 210 may include, without limitation, a wired network adapter, a wireless network adapter, or other device capable of communicating to one or more different networks (e.g., the Internet, an intranet, a private or public LAN, WAN, mobile network, combinations thereof, or other suitable network, etc.) that is either part of the network 110 (as illustrated in FIG. 1), or separate therefrom. In some exemplary embodiments, the processor and one or more network interfaces may be integrated.

Referring again to FIG. 1, each of the communication devices 102a-b in the system 100 is configured to display one or more interfaces to the corresponding users 104a-b. Reference is made hereinafter to communication device 102a and user 104a, with it understood that the description also applies to communication device 102b and user 104b.

While viewing an interface at the communication device 102a, the user 104a may deem a particular object of the interface (e.g., a text segment, an image, etc.) to be of interest. Based on the interest, the user 104a may provide an input to the object of interest at the interface to thereby select (or otherwise identify) the object. For example, when the communication device 102a includes a touchscreen (as output device 206), the user 104a may tap the touchscreen at the object, thereby providing a user input at the object of interest to the communication device 102a (e.g., to the processor 202 of the communication device 102a, etc.).

In the system 100, the selected object of the interface is unlinked, such that the interface (or underlying script) does not define a particular action, in response to the selection of the object. Rather, and uniquely in the system 100, the communication device 102a is configured to capture the object (e.g., select, copy, etc.) to which the user input is applied, and then process the object as desired. For example, following selection of the object, the communication device 102a may display content to the user 104a based on (and generally related to) the unlinked, selected object (e.g., based on a search or other direction, etc.). Or, the communication device 102a may cause the selected object to print at the output device 206, narrow or filter content being viewed based on the selected object, share or send the selected object with/to others, add the selected object with the appropriate context to a search, etc. It should be appreciated that the particular action(s) taken by the communication device 102a following selection of an object may be set by the user 104a as a preference (e.g., as part of a user profile, etc.) at the communication device 102a (e.g., in memory 204, etc.).

In particular, the communication device 102a includes a research engine 112 stored in the memory 204 of the communication device 102a. The research engine 112 is defined by computer-executable instructions, which specifically configure the communication device 102a (i.e., the research engine 112 thereof) to perform various operations described herein. For example, the research engine 112 is configured to receive the selection of the object, by the user 104a, at the communication device 102, and identify the selected object, regardless of whether the object is text, a symbol, an image, a picture, a logo, a video, etc. The research engine 112 then processes the selected object in accordance with a preference of the user 104a (as described above). In the following description, the research engine 112 causes a search to be performed to identify content related to the selected object. As part of the search criteria, in various embodiments, the research engine 112 may include one or more user preferences or other aspects of a user profile (e.g., a current location of the communication device 102a, a residential location of the user 104a, etc.), or context from the interface from which the object was selected, to help tailor the resulting content to the particular user 104a.

The research engine 112 may perform the search within the interface currently being viewed at the communication device 102a. Or, the research engine 112 may cause the search to be performed at one or more of the content sources 108a-c. As such, the content identified, by the research engine 112, may be located within the current interface, or in different interfaces (i.e., different webpages or applications, for example), identified by one or more of the content sources 108a-c. The research engine 112 then causes the identified content to be displayed to the user 104a, at the output device 206 of the communication device 102a. In various embodiments, the research engine 112 may simply launch a search feature within the interface, or within the application supporting the interface, with the search criteria and search command auto-filled (based on the selected object), to identify the content within the interface or within related interfaces associated with the application. Or, the research engine 112 may launch a search engine webpage or web-based application (separate from the interface in which the object was selected) with the search criteria and search command auto-filled, or the research engine 112 may launch an interface (e.g., an application interface, or webpage, etc.), which then incorporates at least a part of the content retrieved or received from the content sources 108a-c. It should be appreciated that the retrieved content may be presented in any desired format including, for example, text, audio, video, paper print, auto-fax or brail, etc.

While the research engine 112 is illustrated as part of communication device 102a in the system 100 (and while a research engine 112 is also illustrated as part of communication device 102b), it should be appreciated that the research engine 112 may be integrated elsewhere in other embodiments. For example, the research engine 112 may be associated with the interface source 106, where the research engine 112 is then included in interfaces, for example, as a toolbar, that can be displayed at the communication device 102a. Additional content may then be found by the user 104a, for unlinked objects in the interfaces displayed at the communication device 102a, by selecting the desired unlinked objects. Or, in some embodiments, some aspects of the research engine 112 may be included at the communication device 102a (and at the communication device 102b) with other aspects of the research engine 112 included at the interface source 106, such that the different aspects of the research engine 112 then communicate in response to a selection of an unlinked object at an interface provided by the interface source 106.

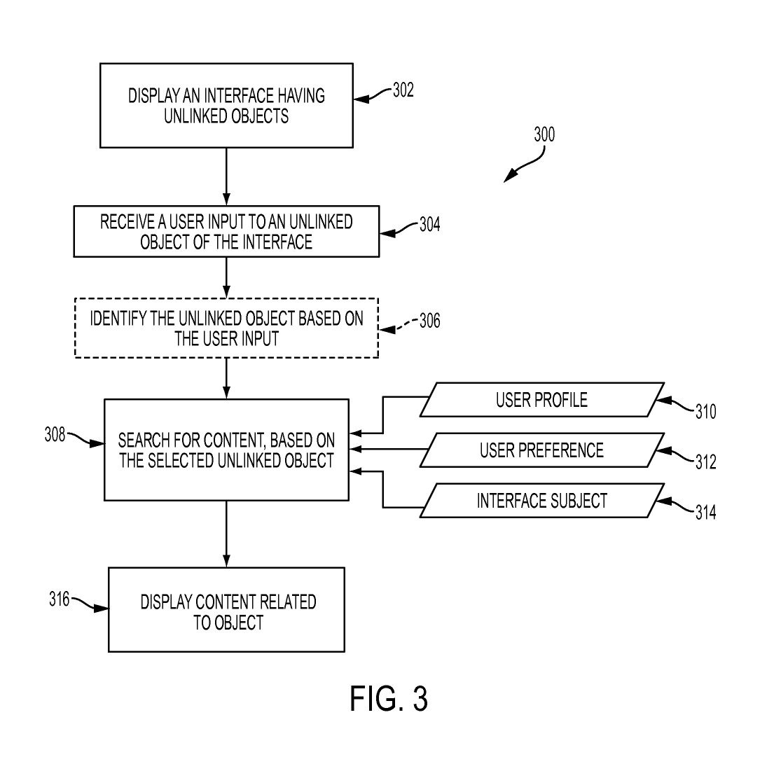

FIG. 3 illustrates an exemplary method, at 300, for displaying content to a user, based on the selection of an unlinked object by the user, for example, text, within an interface. The method 300 is described as implemented in the communication device 102a shown in FIG. 1, with further reference to the user 104a, interface source 106, the content sources 108a-c, and the research engine 112. However, it should be appreciated that the exemplary method 300 may be implemented in combination with other components of system 100, or in other systems or arrangements of systems. And, just as the methods herein should not be understood to be limited to the exemplary system 100, or the exemplary computing device 200, the systems and the computing devices herein should not be understood to be limited to the exemplary method 300.

As shown in FIG. 3, in the method 300, the communication device 102a displays an interface, at 302, to the user 104a. The interface may include, for example, a webpage, an application interface, or another interface suitable to be displayed at the communication device 102a, and in particular, at the output device 206 of the communication device 102a. The interface, and its particular form, and/or the information contained in the interface are provided, via network 110, from interface source 106. For example, a webpage may be provided, almost completely, from the interface source 106 operating as a web server that hosts a website containing the webpage. Conversely, an application, launched by the communication device 102a, may include the form and/or limited content contained in the interface but may rely on the interface source 106 for additional or updated information (e.g., stock quotes, news, recipes, and/or any other data that may change or not change over time, etc.).

The interface displayed at the communication device 102a generally includes information about one or more subjects. Any desired information may be included in the interface, and the interface may relate to any desired one or more subjects. For example, the interface may include a listing of movies currently available for viewing in theaters, provided from a website associated with a particular theater (broadly, a merchant), or from a website associated with multiple different theaters, or from a website associated with a particular studio. In another example, the interface may contain a biography for a particular actor or actress from a website associated with the actor or actress, or generally associated with biographical data, etc. In still another example, the interface may contain national, regional, and/or local news articles provided by a news website and/or a news aggregation website (e.g., cnn.com, foxnews.com, etc.). In yet a further example, the interface may include recipes, stock information, sports scores, etc., through an application associated with the communication device 102a but updated, as appropriate, by a web server associated with the application.

The interface displayed at the communication device 102a also generally includes objects. As used herein, an object may include, for example, text, symbols, images such as pictures and logos, videos, or other discrete or integrated aspects of the interface, etc. Generally, together in the interface, the objects provide information about the one or more subjects to the user 104a.

The objects included within the interface may be linked, or unlinked. A linked object includes coding, within or as part of the interface, that directs the user 104a (or the communication device 102a) to additional, or alternative, content when the object is selected by the user 104a. More generally, a linked object is a coded reference within the interface that permits the user 104a to cause the interface to react to the selection of the linked object (e.g., to display particular information relating to the linked object; to locate to particular information within the interface, or otherwise, relating to the linked object; etc.). For example, in an interface providing a biography of an actor, information in the interface identifying a name of the director of the actor's last film, or a title of some film in which the actor had a role, may include a link, or, for example, a hyperlink. Upon selection of the link, and in response thereto, the interface source 106 may then provide a new interface to the communication device 102a, as indicated by the linked object, with additional content relating to the selected director or title. Specifically, in this example, upon selection at the interface of the linked object of the director's name, the interface may be instructed to display a different interface at a particular address generally containing, for example, a biography of the director. In other examples, selection of a linked object at the interface may simply auto-locate the interface, or the user 104a, to a particular section of the currently viewed interface containing content relating to the selected linked object.

Conversely, an unlinked object is an object without any coding, or other reference, to a prescribed reaction or to a particular interface (or location in a particular interface). The unlinked object, for example, includes simple text or an image or another object, that does not cause the interface to react in any particular manner to a user input that selects the object.

With continued reference to FIG. 3, at 304, the research engine 112 of the communication device 102a receives a user input, at the communication device 102a, to an unlinked object of the interface. The user input may include any suitable input to the communication device 102a. For example, the user input may include, at the output device 206, a tap or click on the unlinked object, or a double tap or click, or even a patterned movement of a tap or click (e.g., a check-mark movement, etc.), etc. Or, the user input may include an eye movement directed toward the unlinked object, as recognition by a camera of the communication device 102a, or a voice command identifying or describing the unlinked object, as recognized by a microphone of the communication device 102a.

In various embodiments, the user input applied to the unlinked object is unique to the particular selection action, so as to distinguish the user input directed toward selecting the unlinked object from, for example, navigational inputs to the interface or inputs to other features of the communication device 102a. In at least one embodiment, for example, the interface, or ancillary application on the communication device 102a associated with the interface, includes a particular button (or other setting) to enable/disable the research engine 112 on the communication device 102a, thereby permitting the research engine 112 to distinguish inputs intended and/or unintended therefor. When the button (or setting) is selected “ON”, or enabled, by the user 104a, the communication device 102a, and in particular the research engine 112, understands subsequent inputs to the interface to be directed to the research engine 112. Conversely, when the button (or setting) is selected “OFF”, or disabled, by the user 104a, the communication device 102a responds to user inputs consistent with conventional operations of the communication device 102a (and as inputs unintended for the research engine 112), such that the research engine 112 ignores and/or is uninformed about the user inputs. Further, the option to employ the research engine 112 may appear to the user 104a (to select or dismiss) in response to the user's selection(s) at the interface. If the user 104a opts to employ the research engine 112 following a selection, the research engine 112 receives the user input as a selection in accordance with the method 300. It should be appreciated that additional buttons, features and/or user inputs may be provided or utilized, at communication device 102a, to identify particular user inputs directed to the research engine 112 and distinguish them from other user inputs.

Upon receipt of the user input to the unlinked object of the interface, at 304, the research engine 112 optionally (as indicated by the dotted lines in FIG. 3) identifies the selected object, at 306. As can be appreciated, some unlinked objects in the interface may be more easily selected by the user 104a than others and, thus, more easily recognized by the research engine 112 than other objects. For example, the user 104a may more easily select a figure from the interface, through the output device 206 of the communication device 102a, than a text segment. As such, when an image is selected at the interface, by the user input, the research engine 112 may easily identify the image as the object. Conversely, when a text segment is selected at the interface, by the user input, the research engine 112 may include the word directly at the user input as well as words adjacent thereto to ensure accurate results (e.g., one, two, three, four, etc., words to the right, left, above, and/or below the word directly selected, etc.). Further operations may be employed, by the research engine 112, at 306, in other embodiments as necessary or desired, to accurately identify an unlinked object selected by the user 104a, which is associated with a user input to the interface. For example, the research engine 112 may highlight, display, or otherwise emphasize the selected object and request confirmation from the user 104a that the selection is correct, whereby the user 104a is able to modify, expand, or compress the selection if not correct.

Next, the research engine 112 processes the unlinked object (i.e., the object selected by the user 104a), from the user input, in accordance with a preference of the user 104a, for example, search for the unlinked object, print the unlinked object, narrow or filter content being viewed (or otherwise) based on the unlinked object, share or send the unlinked object with/to others, etc. In particular in the method 300, the research engine 112 searches for additional content, at 308, based on the unlinked object selected by the user 104a, via the user input to the interface at the communication device 102a (broadly, processes the selected unlinked object). The search is generally directed to the selected object, regardless of type, for example, text, image, symbol, logo, video, etc. In connection with the search, or following the search, the research engine 112 may also operate to narrow the search results, filter the search results, stash the content, erase the selected object, etc., based on predefined rules or user preferences.

In some aspects of the method 300, the research engine 112 may perform the search, at 308, within the interface currently being viewed at the communication device 102a. For example, upon selection of the object, the research engine 112 may initiate a search feature within the interface configured to search for other occurrences of the selected object within the interface, or information related to the selected object based on predefined relationships, etc. The research engine 112 has different contexts available for the user 104a to choose and apply on the selected objects.

In other aspects of the method 300, the research engine 112 may cause the search, at 308, to be performed at one or more of the content sources 108a-c, for example, at content source 108a. In connection therewith, upon receiving the selected object from the user input, the research engine 112 may launch a search engine webpage associated with the content source 108a with the search criteria and search command auto-filled based on at least a part of the selected object. Or, the research engine 112 may provide, to the content source 108a, the appropriate context for the search in addition to providing the selected object. The context may include default context for the particular selected object or category of the selected object (e.g., as defined in a lookup table, etc.), or it may include particular preferences provided by the user 104a.

As further illustrated in FIG. 3 (and as generally suggested above), additional data may be included in the search at 308 by the research engine 112. For example, data from a user profile 310, data from various identified user preferences 312, and data associated with a subject of the interface 314 may be used in the search at 308. Additional data may be used in connection with the search at 308 in other embodiments without limitation.

The user profile 310 may include certain information about the user 104a collected during a registration process, etc. Such information may include, for example, an address for the user 104a, a phone number for the user 104a, interests of the user 104a, hobbies of the user 104, information related to the user 104a and available from public records, etc. The information may be stored in memory 204 of the communication device 102a or it may be pulled from cloud storage or other external services associated with the user 104a, and then used by the research engine 112 when performing the search at 308 to limit and/or direct the search as appropriate. In one exemplary search, for an object that includes the text segment “movie theatre” (broadly, for a merchant), the research engine 112 may determine that the text segment implicates a location requirement and uses the address associated with the user 104a from the user profile 310 (or, in some embodiments, a current location of the communication device 102a based, for example, on GPS data provided by the communication device 102a, a home address, an address designated and/or input by the user 104a, etc.) as part of the search to thereby identify movie theaters in the vicinity of the user 104a.

Similarly, the user preferences 312 may include certain preferences set by the user 104a, at various times, for searches involving particular subject matter, etc. The preferences may again be stored in memory 204 of the communication device 102a or otherwise (as described above), and used by the research engine 112, in similar fashion to the user profile 310, to limit and/or direct the search as appropriate. Such user preferences may include, without limitation, preferred search engines to be used in connection with the search at 308 (e.g., Google®, etc.), trends or preferences identified from previous search histories, connection speed preferences, search criteria suggestions for different selected objects, etc. Further, taking into account such user preferences 312 (or even the user profile 310), selection of the same unlinked object in the same interface by user 104a and by user 104b may cause the research engine 112 to perform differently, based on particular user preferences (or user profile 310) for the different users 104a and 104b.

The subject of the interface 314, to which the user input was provided, may include any subject generally associated with content of the interface. For example, if the interface generally includes different movie titles, and a user input is received for one of the movie titles in the interface, the research engine 112 may identify the subject of the interface to be movies (e.g., based on text in the interface, title of the interface, URL of the interface, metadata for the interface, etc.) and then search for reviews for the selected movie title (understanding the selection to be to one of the movie titles).

In various embodiments, the research engine 112 may also, or alternatively, rely on a data structure (e.g., stored in memory 204 of the communication device 102a, stored in memory 204 of the interface source 106, etc.), in connection with facilitating the search at 308. The data structure may include entries stored therein associated with multiple potential selected objects. In addition, the data structure may include a table, in which categories of objects are included with a prescribed action. The categories may include, without limitation, business names, addresses, biographies, etc., and may be associated with one or more rules, which direct the research engine 112 on how/where to search for content or as to other actions to take. For example, when a selected object includes a text segment comprising a business name, the research engine 112 identifies the text object as a business name and looks up the “business name” category in the tabular data structure, through which the research engine 112 finds the appropriate action(s) corresponding to the “business name” category, for example, search and display locations and days/hours of operation for the selected business. In another example, when a selected object includes a text segment comprising an address, the research engine 112 identifies the object as an address and determines, based on the “address” category in the data structure, to search and display a map of the selected address (broadly, action(s) to be taken). It should be appreciated that a variety of different categories of objects may be included in the data structure, with a variety of different actions prescribed by or associated with selection of objects in the various different categories (e.g., display information relating to the selected object, direct the user 104a to a website relating to the selected object, etc.). It should also be appreciated that the selected object need not have a meaning of its own; in general the selected object is viewed as data by the research engine 112, with context then applied to that data for subsequent processing (e.g., from the various different sources of context described herein, etc.). The results, or output, to the user 104a, from the research engine 112, are then generally based on his/her preferences to and/or the configuration of the research engine 112.

After the particular content is identified via the search at 308, the research engine 112 displays the content (or causes it to be displayed), at 316, to the user 104a, at the communication device 102a. The content may be displayed, for example, at an interface generated by the research engine 112, or as part of an interface generated by one or more of the content sources 108a-c used to perform the search. Or, the content may be displayed to the user 104a in a variety of different interfaces, with the content limited to one “hit” from the search, or multiple “hits” from the search, or to the content prescribed by one or more rules (e.g., from the user profile 310, from the identified user preferences 312, etc.) of data structures stored in memory 204 of the communication device 102a, for example.

The content displayed, at 316, may include, without limitation, information related to the selected unlinked object, and/or may further include one or more options selectable by the user. A selectable option may include, for example, links for further research, options to save, print, share, etc., with other users or other computing devices, etc.

In this manner, through use of unlinked objects, interfaces may be developed more efficiently, without the inclusion of numerous, and potentially cumbersome, links in and/or to the interfaces. As such, the interfaces may be simplified, and revisions to the interfaces (and to other interfaces) may further be simplified. For example, revisions to an interface would no longer include the risk of creating “broken” links, in which, after a revision, a link inadvertently points to a non-existing or expired interface or information. Moreover, by providing further information to users based on unlinked objects, within the interfaces, rather than relying on linking (or separate searching) of an object from the interface, the ability of users to get further information is not limited to linked objects, and thus, user experience with the interfaces is also improved. In fact, in various aspects, the users have input as to what further actions are taken when an unlinked object is selected (e.g., the user has input into what type of search is performed for a selected object, when a search is a desired response to selection of an object; etc.).

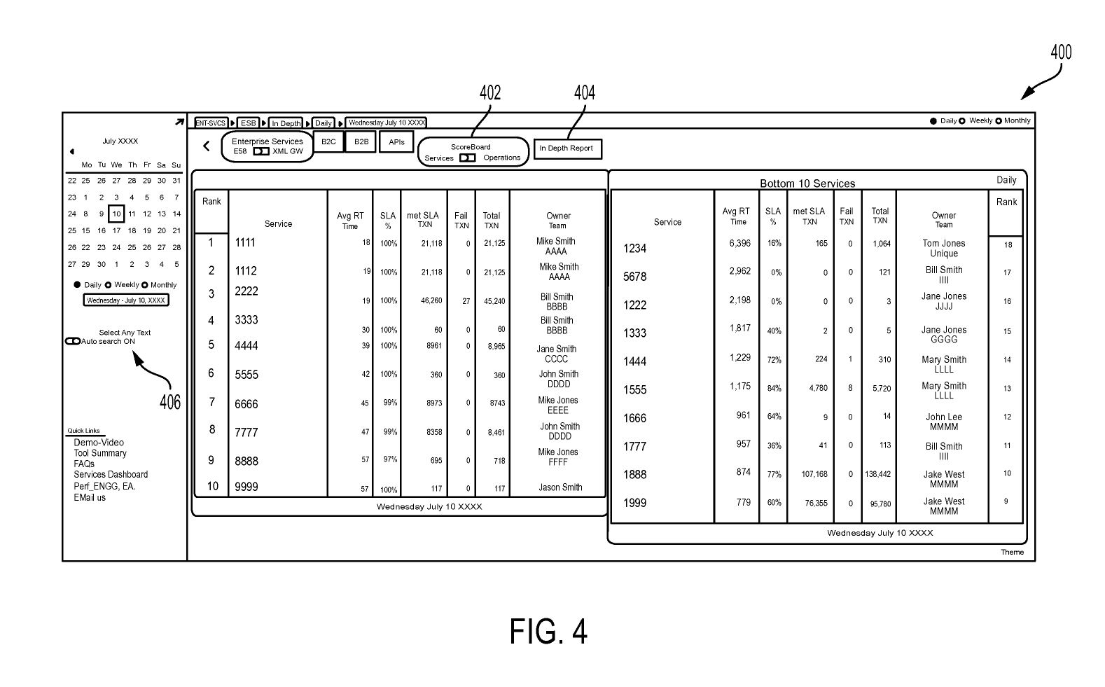

Example applications of method 300, and use of the research engine 112 at communication device 102a of the user 104a, will be described next with reference to FIGS. 4-8. FIGS. 4-8 illustrate different pages of an exemplary interface 400 associated with a performance scoreboard for enterprise services. As desired, the interface 400 can be displayed to the user 104a at the communication device 102a by the interface source 106, for example. The performance scoreboard of this example is used for ranking relative positioning of services and teams based on performance of the services owned by the teams. The performance is based on response times of transactions and percentages of the transactions that meet one or more defined thresholds for the particular services. Though the performance scoreboard shows the ranking, the users can select (e.g., double click, etc.) any text on the scoreboard (consistent with the systems and methods described herein) to further view associated details. In addition, the users can select team names to view the particular services owned by the selected teams.

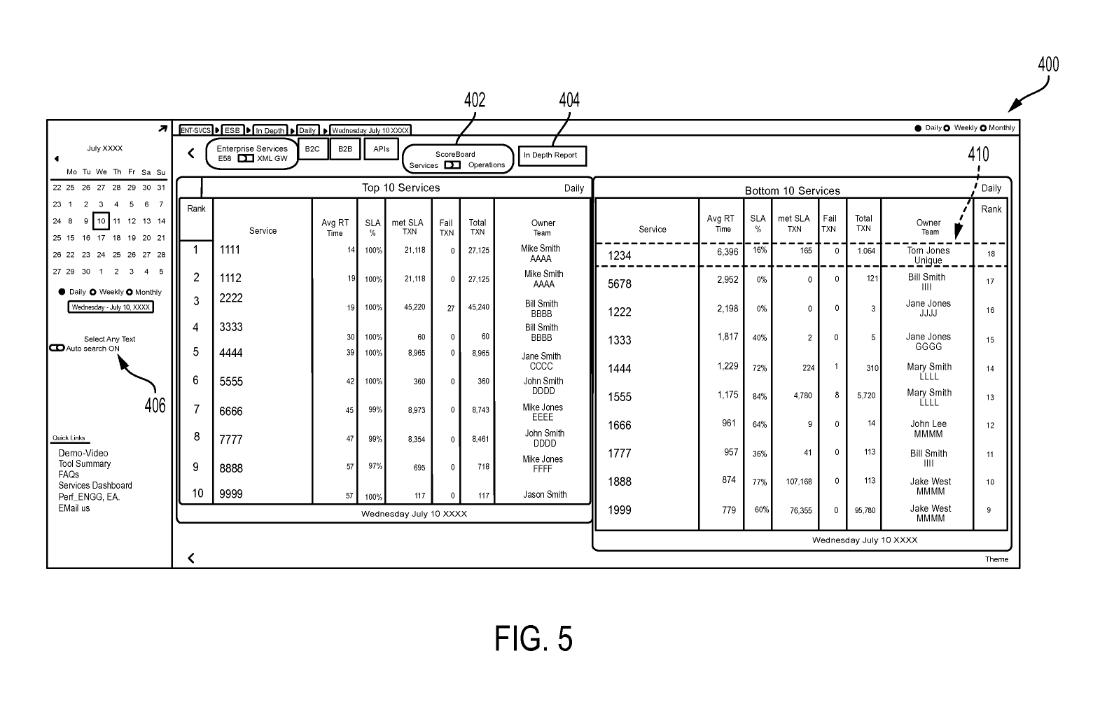

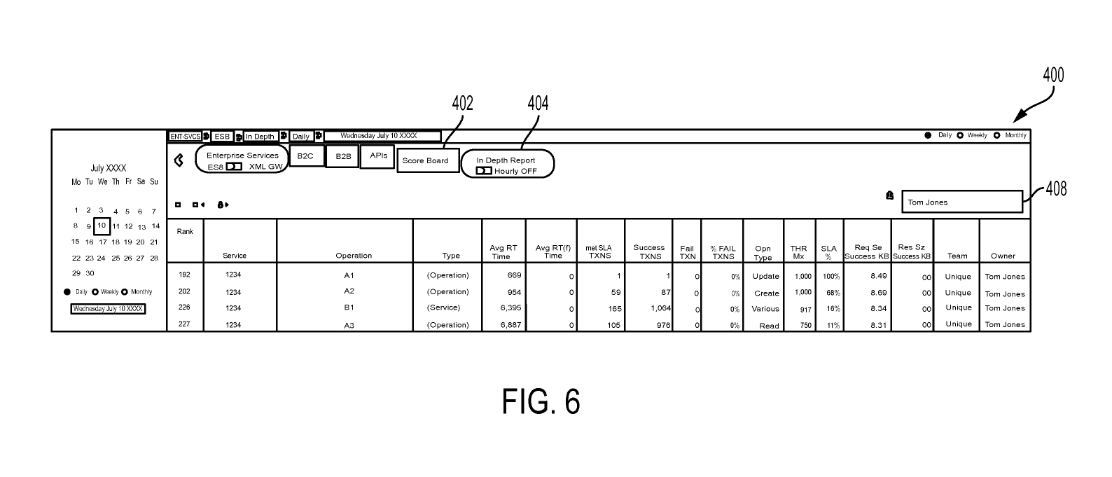

As shown, the interface 400 includes multiple tabs, or screens, for use in displaying different unlinked data to the user 104a relating to enterprise services. For example, in FIGS. 4 and 5, a ‘ScoreBoard’ screen 402 is active, with various unlinked objects (or data) associated with the ‘ScoreBoard’ screen 402 shown, or displayed, through the interface 400. In FIGS. 6-8, an ‘In Depth Report’ screen 404 is active, with various unlinked objects (or data) associated therewith shown through the interface 400.

The interface 400 also includes button 406 configured to enable/disable the research engine 112 on the user's communication device 102a when the interface 400 is displayed. When the button 406 is selected “ON” by the user 104a, the communication device 102a, and in particular the research engine 112, understands subsequent inputs to the interface 400 (e.g., to the screens 402, 404 of the interface 400, etc.) to be directed to the research engine 112 for use in a search operation. Conversely, when the button 406 is selected “OFF” by the user 104a, the communication device 102a responds to user inputs consistent with conventional operations of the communication device 102a (and not as inputs to the research engine 112). In addition in this example, the ‘In Depth Report’ screen 404 of the interface 400 (FIGS. 6-8) also includes a search box 408 that may be used by the user 104a, as desired, to manually search for desired content in the interface 400.

As such, in these example applications, in response to a selection of an unlinked object in the interface 400 by the user 104a, the research engine 112 is configured (e.g., by default, by preferences from the user 104a, etc.) to perform a search and provide additional information to the user 104a associated with the particular selection.

With reference to FIGS. 4-6, in one example application, when the button 406 is “ON” in the interface 400 (as shown), subsequent inputs to the ‘ScoreBoard’ screen 402 will be used by the research engine 112 in connection with a search for related content within the interface 400. As such, when the user 104a selects ‘Tom Jones’ in the ‘ScoreBoard’ screen 402, i.e., object 410 as shown in FIG. 5, for example, the research engine 112 activates the ‘In Depth Report’ screen 404 and displays all available entries for Tom Jones (as shown in FIG. 6). Here, the user 104a may have a preference, stored in memory 204 of the communication device 102a, indicating that when a selected object at the ‘ScoreBoard’ screen 402 includes a name, display the ‘In Depth Report’ screen 404 and all entries for the selected name.

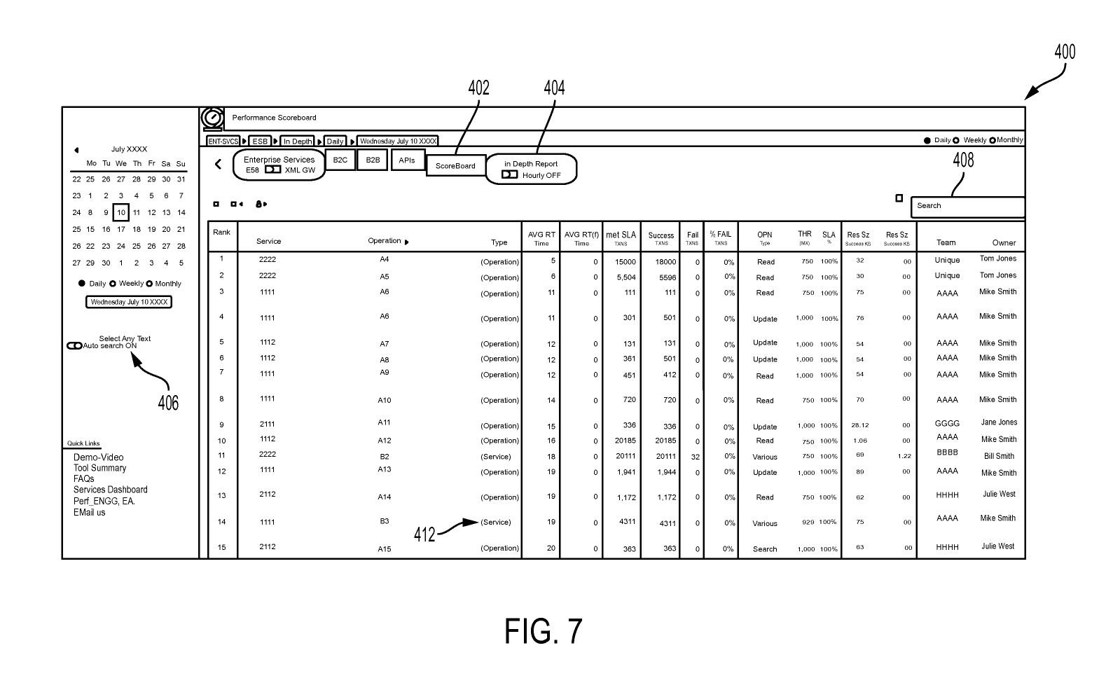

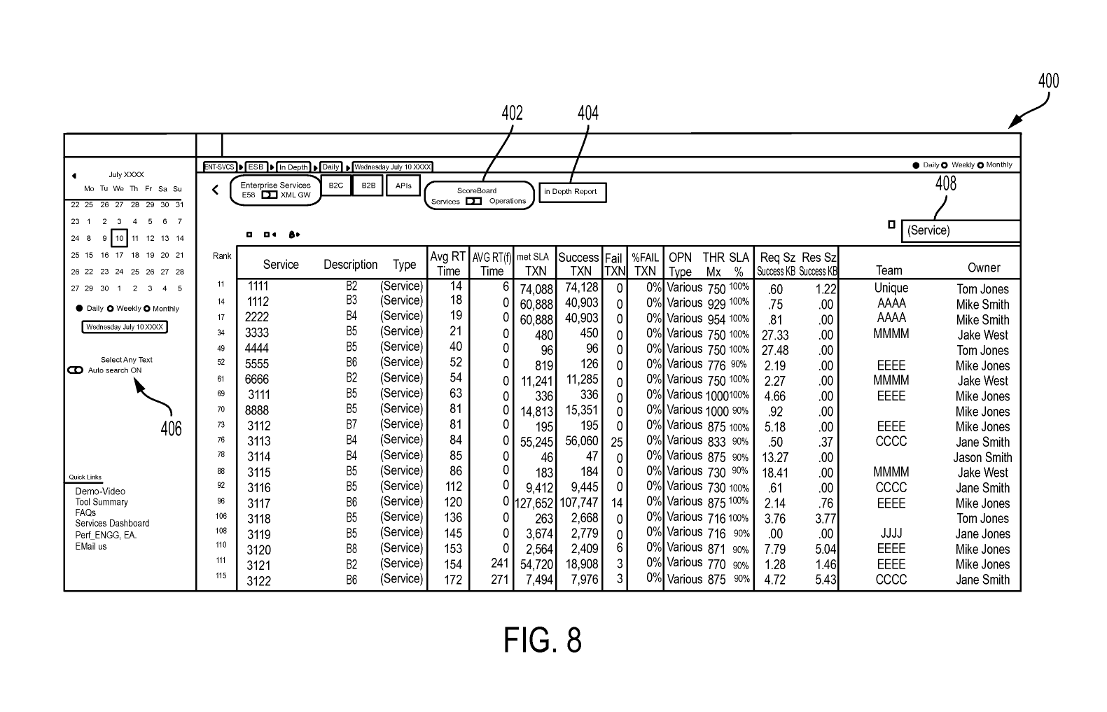

With further reference to FIGS. 7 and 8, in another example application, when the button 406 is “ON” in the interface (as shown), subsequent inputs to the ‘In Depth Report’ screen 404 will be used by the research engine 112 in connection with a search for related content within the ‘In Depth Report’ screen 404. As such, when the user 104a selects unlinked object or term ‘(service)’ in the ‘In Depth Report’ screen 404, i.e., object 412 as shown in FIG. 7, for example, the research engine 112 auto-populates the search box 408 with the selected object ‘(service)’ so that a search is perform within the ‘In Depth Report’ screen 404 for all service-type operations. In response, and as shown in FIG. 8, only the service-type operations are then displayed in the ‘In Depth Report’ screen 404. The selected object ‘(service)’ may also be identified adjacent the button 406, in some examples, as an indication of the searching operation. Here, the user 104a may have a preference, stored in memory 204 of the communication device 102a, instructing the research engine 112 to auto-populate the search box 408 with any selected object when such selection is made at the ‘In Depth Report’ screen 404.

Again, and as previously describe, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) causing an interface to be displayed at a communication device where the interface includes objects displayed to a user at the communication device, and where the objects include at least one unlinked object; (b) receiving, at the communication device, a selection from the user to the interface of the at least one unlinked object; and (c) causing content, based on the selected at least one unlinked object, to be displayed at the communication device.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A system for use in outputting content to a user, based on selection of an unlinked object in an interface, the system comprising:
at least one computing device associated with a user, the at least one computing device including an output device and executable instructions, which define at least part of a research engine, the research engine configured to:
receive a user input at an interface displayed at the output device;
identify an unlinked object within the interface and associated with the user input in response to said user input, the identified unlinked object associated with a category;
identify content for the unlinked object based on the category associated with the identified unlinked object; and
display, at the output device, at least a portion of the identified content to the user.

2. The system of claim 1, wherein the output device includes a touchscreen; and wherein the research engine is configured to:
display said interface, to the user, at the touchscreen;
receive the user input, at the touchscreen; and
display the at least a portion of the identified content at the touchscreen device of the communication device.

3. The system of claim 2, wherein the research engine is configured to search for the category of the identified unlinked object in a tabular data structure and to perform at least one action corresponding to the category in the tabular data structure, to thereby identify said content.

4. The system of claim 3, wherein the at least one action corresponding to the category includes at least one search, via one or more search engines, for the identified object.

5. The system of claim 4, wherein the research engine is further configured to search, via the one or more search engines, for the identified object and at least one of a subject of said interface and/or a user preference, to thereby identify content for the unlinked object.

6. The system of claim 1, wherein the research engine is further configured, by the executable instructions, to distinguish said user input from a different user input to the interface unintended for the research engine.

7. The system of claim 1, further comprising an interface source including executable instructions, which define at least part of the research engine; and
wherein the research engine is configured to cause the at least a portion of the identified content to display at the at least one computing device associated with the user.

8. A non-transitory storage media including computer-executable instructions that, when executed by one or more processors, cause the one or more processors to:
cause an interface to be displayed, the interface including at least one unlinked object, whereby said interface lacks a defined action for selection of the at least one unlinked object;
receive a selection, from a user, to the interface of the at least one unlinked object;
search, via one or more search engines, for content related to the selected at least one unlinked object, based on a subject of said interface, a category of the at least one unlinked object and/or a user preference; and
cause at least a portion of the content identified in the search to be displayed to the user at a communication device.

9. The non-transitory storage media of claim 8, wherein the selected at least one unlinked object is a text object.

10. The non-transitory storage media of claim 9, wherein the user preference includes a preferred search engine; and
wherein the computer-executable instructions, when executed by the one or more processors, cause the one or more processors to search via said preferred search engine.

11. The non-transitory storage media of claim 8, wherein the computer-executable instructions, when executed by the one or more processors, cause the one or more processors to search based on an address associated with the user, when the selected unlinked object includes one or more merchants.

12. A computer-implemented method for use in displaying content at a computing device associated with a user, in response to an input to an object at an interface displayed at the computing device via one or more networks, the interface including at least one linked object and at least one unlinked object, the method comprising:
causing an interface to be displayed at a communication device, the interface including objects displayed to a user at the communication device, the objects including at least one unlinked object;
receiving, at the communication device, a selection from the user to the interface of the at least one unlinked object; and
causing content, based on the selected at least one unlinked object, to be displayed at the communication device.

13. The method of claim 12, further comprising searching, based on the selected at least one unlinked object, via one or more search engines, for the content; and
wherein causing content to be displayed includes causing content, at least identified by the searching, to be displayed.

14. The method of claim 13, wherein the interface is associated with a webpage and/or an application; and
wherein searching for the content is further based, at least in part, on a subject of said interface, the webpage and/or the application.

15. The method of claim 13, wherein searching for the content is further based, at least in part, on at least one preference associated with the user.

16. The method of claim 12, wherein the objects included in the interface include text segments, and wherein the selected at least one object includes at least one of the text segments.

17. The method of claim 16, wherein the selected at least one of the text segments includes a word selected by the user in the interface, and further includes at least two words to a right of the selected word and at least two words to a left of the selected word.

18. The method of claim 12, further comprising, prior to receiving a selection from the user, receiving a research engine enabling input at the communication device indicating at least the next input includes said user selection.

19. The method of claim 12, further comprising searching in a data structure for the selected object, or part thereof; and
wherein causing content to be displayed includes causing content, at least associated with the data structure, to be displayed.

20. The method of claim 12, wherein causing content to be displayed includes causing at least two selectable options, related to the selected object, to be displayed.
